(19) United States
(12) Patent Application Publication
(10) Pub. No.: US 2020/0269204 A1
(43) Pub. Date: Aug. 27, 2020

(54) METHOD AND ASSEMBLY FOR PRODUCING COATED PRILLS OR GRANULATES, PRILLS OBTAINED THEREWITH, AND USE THEREOF

(71) Applicants: thyssenkrupp Industrial Solutions AG, Essen (DE); thyssenkrupp AG, Essen (DE)

(72) Inventors: Yevgeny MAKHYNYA, Mülheim (DE); Evgeni GORVAL, Dortmund (DE); Leo KAGALOWSKI, Herdecke (DE)

(73) Assignees: thyssenkrupp Industrial Solutions AG, Essen (DE); thyssenkrupp AG, Essen (DE)

(21) Appl. No.: 16/649,695

(22) PCT Filed: Sep. 27, 2018
(86) PCT No.: PCT/EP2018/076240

§ 371 Date: Mar. 23, 2020

(30) Foreign Application Priority Data
Sep. 29, 2017 (DE) 10 2017 217 498.6

(51) Int. Cl. B01J 2/00; B01J 2/12; B01J 2/16

(52) U.S. Cl. CPC B01J 2/006; C05G 5/37; B01J 2/16; B01J 2/12

(57) ABSTRACT

A process for producing prills, in particular fertilizer prills, coated with at least one biologically degradable polymer layer, in particular a PLA layer, may involve applying a degradable polymer layer to a carrier material of the respective prill in a drum coating step, in particular in a drum coater at relative negative pressure, and then coating the prills with a second degradable polymer layer on top of the first degradable polymer layer in a fluidized bed coating step, in particular in a fluidized bed coater at a relative positive pressure. Coating the prills with the second degradable polymer layer may involve introducing the prills into a fluidized bed coater after the drum coating step, and the fluidized bed coating step may be performed spatially adjacent alongside the drum coating step.

The invention relates to a process and an apparatus for producing coated prills or granules. In particular, the invention relates to a process and an apparatus according to the preamble to the respective independent claim.

Prills can be distinguished from conventional granulated particles (granules) or from pellets and pastilles, in particular when used as fertilizer. Granulated bulk materials feature high strength and comparatively large size. Granules are produced in layers (layer-by-layer, what is called “onion skin”) in a crystallization process and can be of different sizes. Special types of granules (in particular pellets or pastilles) are produced in particular by pressing a melt through a screen, the solidified particles (in particular lens-shaped) being mechanically removed from the screen. The pellets can especially be provided extruded as a strand, however, in the field of fertilizers pellets have to date hardly been used or at most have been used as natural fertilizers (manure, humus), or at least have been used less frequently than granules or prills.

In contrast, prills are products of prilling, that is to say fine-grained material, often in round or droplet form, with a particle size of approx. 2 to 3 or more rarely also up to 4 mm. Molten material is sprayed into a tower from above, so that droplets form in free flight which cool and solidify under forced convection or an air draft that is present anyway. Granulating aids are not absolutely necessary in this case, but they are very often used in particular by way of admixture into the melt prior to the prilling. The granulating aid used as standard is urea-formaldehyde (UF) solution. The particle size depends on the length of the free flight and optionally additional (forced) air cooling, but it cannot be modified as desired. With respect to urea in particular, this process, together with granulation, is the most frequently selected process. Prills and granules are often at least approximately round particles, pellets are often semicircular.

Compared to granulated particles (in particular also in the case of fertilizers), prills often have disadvantages with respect to mechanical properties (e.g. clump formation, breaking), in particular with the consequence that relatively high losses of fertilizer occur during transport, storage and general use. This also results in the material or the fertilizer being distributed inhomogeneously, that is to say non-uniformly.

In the case of prills it is therefore of interest, largely independently of any particular field of application, to be able to ensure good mechanical properties, in particular high compressive strength, abrasion resistance, impact resistance, and also as far as possible to avoid a tendency toward caking. Good chemical compatibility is also desirable.

Urea is currently the nitrogen fertilizer having the greatest global demand. Of the total quantity produced, only very modern plants deliver granulated urea; using older plants it is often only possible to provide urea in prilled form.

The release of the fertilizer over time can often not be controlled sufficiently precisely, if at all, in the case of the pellets or prills in common use to date. The release or emission of active substances occurs over relatively short periods of time, that is to say far too fast for the plant to be able to take up the active substance, and therefore leads to high fertilizer losses (up to 80%) and accordingly also to unnecessary pollution of the environment. Last but not least, a greater amount of work results, for example fertilization has to be carried out more frequently or different fertilizers have to be applied.

Patent specification EP 1 890 985 B1 describes a coated fertilizer having a controlled release of active substance. Laid-open specification DE 196 03 739 A1 describes mixtures of fertilizer granules. Laid-open specification EP 0 763 510 A1 describes a polymer layer sprayed on by means of fluidized bed granulation. Patent specification U.S. Pat. No. 9,266,787 B2 describes fertilizers having a polymer layer with a specific thickness.

The publication by M. Devassine et al.: Coating of fertilizers by degradable polymers; International Journal of Pharmaceutics 242 (2002) 399-404; describes advantages of a fluidized bed process with respect to the surface properties of the layer applied.

DE 692 21 854 T2 discloses a sulfur-coated fertilizer and a process for the production thereof. In this case, the production of the fertilizer comprises the application of a sulfur layer and of a subsequent polymeric top layer. Pages 1 and 2 refer to the differences of polymer- or resin-coated fertilizers compared to sulfur-coated fertilizers. Reference is made on page 21, 2nd paragraph, to the temperature sensitivity and hence the specific features of the coating with sulfur and polymers.

However, it has not been known to date how the prills can be produced in order to realize as many advantages as possible together and at the same time also to remain flexible with respect to the production process.

The object of the invention is to provide an apparatus and a process for producing or modifying prills with which as many advantages as possible with respect to the material structure of the prills or with respect to the release of active substance or fertilizer and also with respect to the possibilities for variation in the production process can be realized jointly with one another.

This object is achieved according to the invention by a process for producing or modifying prills or granules, in particular fertilizer prills, coated with at least one biologically degradable polymer layer, in particular PLA layer, wherein the at least one degradable polymer layer is applied to a carrier material of the respective prill, wherein the prills are first coated with at least one first (lower) degradable layer on the carrier material in a drum coating step, in particular in a drum coater at relative negative pressure, and then are coated with at least one second degradable layer on top of the first layer in a fluidized bed coating step, in particular in a fluidized bed coater at a relative positive pressure. The two-layer structure enables a synergy of advantages from both processes and from both types of layer.

The process according to the invention gives rise to various advantages, in particular a two-stage release, in particular two-stage with respect to time and/or with respect to the nature of the active substance or fertilizer released. It has been found that the carrier material can be released by the drum coating layer(s) within a few hours, and that a noticeable release by the fluidized bed coating layer(s) only takes place after a markedly longer time, in particular over 50 or 100 h. A so-called “slow release” or “controlled-release” behavior can be established in a simple way by means of the layer structure according to the invention.

Owing to the two-layer layer structure according to the invention, the release of the fertilizer in the soil is delayed. The release may also take place here by diffusion and as a result of defects in the layer structure. The release rates may for example be set in proportion to the layer thickness.

The nature and number of the defects can be set depending on the nature of the coating (nature of application). In particular, the resistance to abrasion, caking and crushing is also increased. The mechanical properties of the individual prill are improved. Mass losses can be reduced to at least approximately 0%, in particular by means of comparatively little polymer material, that is to say by means of a comparatively thin coating.

The coating of the prills can be described as a modifying, since the prills as such (without coating) can be produced as standard in a prilling tower. The two layers can each be applied by a specific coating process in such a way that the release rates can be set in a targeted manner. Optionally, a plurality of first layers may be applied by a first coating process (in particular drum coating) and a plurality of second layers may be applied by a second coating process (fluidized bed coating).

The drum coater provides a coarse, robust, structurally stable covering or coating of the carrier material of the prill. The fluidized bed coater (also called fluid bed coater) enables, for example, a minimization of the number of defects by means of a kind of improvement of the at least one first lower layer. The material composition of the layers may be identical in this case. Further advantages for the process and the end product also result from the fact that the quality of the first layer has to be checked less critically, since a surface with high quality can be provided by means of the second layer, by means of which any disadvantages of the first layer can be compensated.

“Coater” is understood here to mean a coating device for applying at least one layer.

When referring to the term “prill”, this can in each case analogously also refer to the term “granules”. The processes and apparatuses described here can be set up for handling both prills and granules.

It has also been found that consumption costs can be minimized using the combination of drum coater and fluidized bed coater, in particular compared to a single large fluidized bed coater (that is to say without the process combination with drum coater).

The carrier material can be provided by the base material provided for the respective application case, in particular by fertilizer. The carrier material can in particular consist exclusively of fertilizer. The first layer can be applied directly to the surface of the carrier material, in particular without any specific pretreatments of the surface.

Chlorinated solvents are not required for the coating. The choice of solvents can be restricted to environmentally friendly solvents, in particular to acetone and/or CO2. It has been found that a sequential combination of solvents is particularly advantageous.

In this case, the respective polymer layer or the PLA (polylactide) can be applied to any desired carrier, in particular applied as a solution, with the solvent being evaporated and optionally recovered.

Preceding steps for particle formation, that is to say for spraying or granulating or pelletizing the (possibly molten) carrier material are independent of the coating steps here. The coating can in each case be effected in a separate stand-alone apparatus or assembly. Nevertheless, the (residual) heat from the preceding steps may be utilized.

Examples of carrier materials (that is to say fertilizers) that can be mentioned include: urea, ammonium nitrate, ammonium sulfate. The carrier material (fertilizer) is preferably in the solid state during the production, in particular in a granular state. Prilling and granulating aids, in particular UF (urea-formaldehyde) solution, can optionally be dispensed with. Instead, the particles can be stabilized by applying thin polymer layers.

An absolute coating thickness of max. 200 μm or PLA content of about 5% by weight of overall fertilizer has proven to be optimal for numerous applications.

The combination of different coating thicknesses, with a portion of the prills (preferably below 25% by weight) being uncoated or only mechanically stabilized (PLA input in particular <1% by weight) and further portions each having different PLA coatings (in particular between 3% and 15% by weight), depending on the target plant, the target climate and the target soil, have proven to be particularly efficient for a controlled release of the active substance/fertilizer contained in the carrier material. In this way, the plant can be supplied in each case with the optimal amount of active substance during a vegetation period and/or the number of required fertilizations can be reduced. In particular, any water-soluble fertilizer can be provided by means of the carrier material.

The present invention provides a prilled fertilizer coated with a biologically degradable polymer substance the individual decomposition products of which are harmless to the environment. The polymer substance is preferably at least partly provided by PLA, in particular with a proportion by weight in the overall fertilizer of between 0.05% and 15%. In particular, a mixture can be provided in which uncoated prills and polymer-/PLA-coated prills are present, in particular with a proportion of uncoated prills of between 1% and 50% by weight. In this case, urea can be used as fertilizer, in particular in that urea is provided as a component of the carrier material or forms the carrier.

As first layer, in particular polymer/PLA is applied using acetone as solvent. As second layer, in particular polymer/PLA is applied using CO2 in supercritical state as solvent.

The at least one first and one second polymer layer may be formed from the same polymer or from different polymers, in particular both from biologically degradable polymers.

In one embodiment, the second coating step is conducted (preferably immediately) after the first coating step by introducing the drum-coated prills into the fluidized bed coater after coating by the drum coater has been performed, in particular within less than 1 to 5 minutes. This makes an expedient combination of methods possible. A possibly advantageous rest phase or drying phase may optionally be provided here in connection with the first coating step.

In one embodiment, the second coating step is conducted spatially adjacent alongside the first coating step, in particular within a radius of 5 to 15 m. This makes an expedient combination of methods possible. In this case, thermal energy from the first coating step may also be utilized.

Interim storage is not necessarily required. The overall assembly can remain very compact.

It is advantageous, in particular also with regard to operating costs, to conduct the first coating step in a time-efficient manner, in particular at most for as long as the second coating step. The particular duration depends on the process parameters selected.

In one embodiment, the second coating step is conducted after a rest phase or drying phase after the first coating step, in particular after a rest phase or drying phase of at least one to three minutes, optionally also after a phase of a plurality of hours or days. In this way, the prills can be provided in an optimized manner for the second coating step.

Depending on requirements, a decision can be made as to how much material or polymer should be applied in the second coating step. In particular, the prills can also be heated to a setpoint temperature in a controlled manner, so that the process conditions during the coating can be set very precisely.

The duration of the rest/drying phase can depend on the process regime, in particular on how quickly spraying is effected, how highly concentrated the solution is, or which solvent is used.

The drying phase provides the advantage of being able to expel residual moisture to the maximum extent. In particular, clumping of the granules or of the prills can be prevented. The rest/drying phase may for example be realized in a continuously operated drum coater (in particular in the form of a tube) in which drum coater the final section is used for the drying without the prills or the granules being sprayed in the process.

In one embodiment, the proportion by weight of the degradable layers is in the range from 0.05% to 20%, in particular 0.05% to 10% or 0.05% to 5% of the mass of the respective prill. The manner of the release can be influenced in a broad spectrum as a result of this.

In one embodiment, the proportion by weight of the first degradable layer is in the range from 0.05% to 15% of the mass of the respective prill. In one embodiment, the proportion by weight of the second degradable layer is in the range from 0.05% to 5% of the mass of the respective prill. In one embodiment, the layer thickness of the applied layers in absolute terms is in the range from 1 to 500 μm, in particular from 1 to 200 μm. In one embodiment, the first layer is at least as thick as the second layer. In one embodiment, the ratio of the layer thicknesses or proportions by weight of the first layer compared to the second layer is in the range from 20:1 to 1:1. These features are combinable with one another and each provide an advantageous construction of the prills in respect of structure and release properties.

In one embodiment, in the first coating step a temperature in the range from 0 to 130° C., in particular 30 to 70° C. or 50 to 60° C., is set. This can optimize the drum coating.

In one embodiment, in the second coating step a temperature in the range from 0 to 90° C., in particular lower than the temperature in the first coating step, in particular room temperature, is set. This can optimize the fluidized bed coating.

In one embodiment, in the first and second coating step a ratio of the set temperatures is set in the range from approx. 2:1 or 3:1 or 4:1 (first temperature compared to the second temperature). This provides an advantageous temperature range in each case in order to optimize the respective coating process. The respective coating device can have heating devices set up for this purpose.

It has been found that a comparatively low temperature is particularly advantageous in the respective coating step. Relatively high temperatures (approx. at least 100° C.) in conjunction with a long treatment duration can influence the properties of the product. An advantageous temperature range of approx. 50 to 60° C. for the drum coater and approximately room temperature for the fluidized bed coater were able to be determined from experimental results.

In one embodiment, in the first coating step a (negative) pressure in the range from 1 to 0 bara is set, for example 500 or 700 mbara. In one embodiment, in the second coating step a pressure in the range from 1 to 10 000 mbar (10 bar), in particular 1 to 500 mbar (0.5 bar) above atmospheric pressure is set. In one embodiment, in the first and second coating step a ratio of the set pressures is set in the range from approx. 1:1.5 or 1:2 or 1:3 or 1:4 (first pressure compared to the second pressure). This can optimize the respective coating step.

It has been found that as low a pressure as possible should be set in the drum coater. The pressure can be set according to the pressure resistance of the drum coater. In particular, the drum coater is set up for a negative pressure in the range of at least 100 to 800 mbar below atmospheric pressure. The preferred pressure range depends in particular on the choice of solvent.

In one embodiment, the first and second degradable polymer layer in each case comprise a layer of biologically degradable PLA or are formed thereby, in particular a first PLA layer of a first type and a second PLA layer of a second type. In this way, particularly advantageous properties can be set when constructing the layers.

In one embodiment, the first degradable polymer layer has a clew-like, pore-rich structure and the second degradable polymer layer has a plaster-like, dense low-pore structure. This enables the combination of various advantageous effects, in particular in that first a coarse layer is applied comparatively quickly and cost-effectively, and thereafter this layer is improved by means of a further layer. It has been found that a clew-like structure can be achieved in a particularly simple manner by means of the drum-coater coating, and a plaster-like surface structure can be achieved by means of the fluidized-bed-coater coating. The polymer layers can both be crystalline or amorphous here.

The composition of the individual PLA layers may be specified as follows. Firstly by the molar mass (average molar mass of the polymer unit) as a measure of the polymerization: the higher the molar mass, the more stable and durable the polymer. With a low mass, the polymer is unstable for example with respect to hydrolysis and has a tendency to break down into oligomers and monomers. Secondly, specification may also be made via the state “crystalline” or “amorphous”. Amorphous polymer or PLA for example has a markedly lower melting point than crystalline polymer or PLA.

The composition of the individual polymer or PLA layers can be the same. Owing to the process combination according to the invention, various qualities of the polymer or PLA can be used, or at least one of the layers (in particular the first, coarser layer) can be admixed with further substances (e.g. additional layer as polymer blends or additional micronutrients or additives).

In one embodiment, in at least one of the coating steps a solvent is used, in particular individual solvents are used in each case, in particular first a solvent from the group of aliphatic ketones, alkyl aromatics, esters of acetic acid and lactic acid, acetone in the drum coating step and then the same solvent or a CO2 solvent in the fluidized bed coating step. This enables an optimization of the respective process step or of the respective layer.

In one embodiment, in at least one of the coating steps, preferably in both coating steps, chlorine-free solvent is used, in particular acetone and/or CO2. This makes it possible to dispense with chlorine-containing solvents.

In one embodiment, in the second coating step chlorine-free solvent comprising CO2, in particular in the supercritical state (scCO2), is used, in particular for the production of ammonia. This also makes an efficient process possible, in particular also in terms of time.

In any case, a solvent is preferably used in the first coating step (in particular acetone). In the second coating step, it is only optionally necessary to work with solvent, in particular with the same solvent as in the first coating step. As an alternative, CO2 or scCO2 (supercritical CO2) can be used in the second coating step (fluidized bed coater), having the advantage of being able to produce very concentrated (PLA) solutions. Here, CO2 can be obtained from the processing assembly (in particular from CO2 scrubbing, in particular in connection with an ammonia synthesis or an ammonia-urea complex).

CO2 in the supercritical state provides the advantage of a high solubility, where by means of CO2 in the supercritical state properties of the solvent which are similar to organic solvents can be utilized. Besides acetone and CO2, a further solvent that may be mentioned is in particular toluene.

The abovementioned object is also achieved according to the invention by a processing assembly for the production of prills or granules coated with at least one biologically degradable polymer layer, in particular PLA layer, wherein the processing assembly comprises at least one drum coater as a first process stage and at least one fluidized bed coater as a second, downstream process stage, each configured for the coating of the prills with at least one biologically degradable polymer layer. This provides abovementioned advantages.

In one embodiment, the assembly comprises at least one device for the generation of a negative or positive pressure and for the generation of a pressure difference between the first and second process stage. By means of this, the respective process steps and layers can be conducted/applied in an optimized manner.

In one embodiment, the assembly has a device for receiving the prills that have been coated in the drum coater, the device being configured for transferring the prills to the fluidized bed coater and having an outlet or a coupling corresponding to an inlet of the fluidized bed coater. In this way, an intermediate step for the treatment or interim storage of the prills can optionally be provided.

In one embodiment, the processing assembly comprises a device having a drying function interposed between the drum coater and the fluidized bed coater. This enables the optimization of the second step, in particular by preparing the prills specifically for it. The drying function is optionally at least partially integrated into the drum coating unit.

The abovementioned object is also achieved according to the invention by the use of a processing assembly comprising at least one drum coater and at least one fluidized bed coater, in particular a processing assembly described above, for the two-stage production or modification of prills with a polymer coating, in particular PLA coating comprising at least two layers each applied in one of the stages. This provides abovementioned advantages.

The abovementioned object is also achieved according to the invention by prills, in particular fertilizer prills, having at least two layers produced by at least two-stage coating of a carrier material of the prills with at least one first degradable polymer layer, in particular PLA layer, applied by drum coating and with at least one second degradable polymer layer, in particular PLA layer, applied by fluidized bed coating, in particular by means of a process described above or a corresponding assembly. This provides abovementioned advantages.

By applying at least one first layer produced by the first coating step and at least one second layer produced by the second coating step, many of the abovementioned advantages can be realized. In particular, the layer applied later can seal the at least one first, lower layer or repair defects in the latter.

The abovementioned object is also achieved according to the invention by a prill mixture, in particular comprising a first type of prills according to the preceding description, provided or produced by two-stage coating of a portion of the prills by means of drum coating (device) and fluidized bed coating (device) with at least two polymer layers and mixing of these two-layer prills, wherein a/the first type of prills characterized by an at least two-layer polymer or PLA coating, in particular comprising 1% to 20% by weight or 3% to 15% by weight (in relation to the mass of the prills), is mixed with a second type of prills characterized by at least one mechanically stabilizing layer, in particular a polymer or PLA layer comprising less than 3% or 2% or 1% by weight (in relation to the mass of the prills), and/or wherein the first type of prills is mixed with a further (third) type of prills without any coating, in particular in each case in a ratio of at least 1:1 or at least 2:1 or at least 3:1, in particular with less than 50% by weight, in particular less than 25% by weight, content of the second and/or further (third) type of prills in relation to the total mass of the prill mixture. This provides abovementioned advantages.

The prills (in particular of the second type) may in this case be stabilized in particular with urea solution or UF (urea-formaldehyde) solution. The prills of the second type can optionally be coated with PLA instead of UF solution.

The lower limit for the proportion of the uncoated prills of the third type is in this case above 1% by weight, preferably above 5% by weight, more preferably above 10% by weight. The third type of prills can be characterized here by a carrier material in the form of fertilizer, where the prill may be formed completely from fertilizer so that the fertilizer is released immediately, that is to say completely without any regulating or blocking layer.

Here, the first type of prills may have the two layers having different PLA proportions by weight of the first layer and of the second layer (in each case in relation to the total mass of the prills), for example 20% and 3%, or 50% and 5%, or 20% and 10% (the thinner layer in each case is the second layer).

Further features and advantages of the invention are apparent from the description of at least one exemplary embodiment with reference to drawings, and from the drawings themselves. These show, in each case in schematic representation,

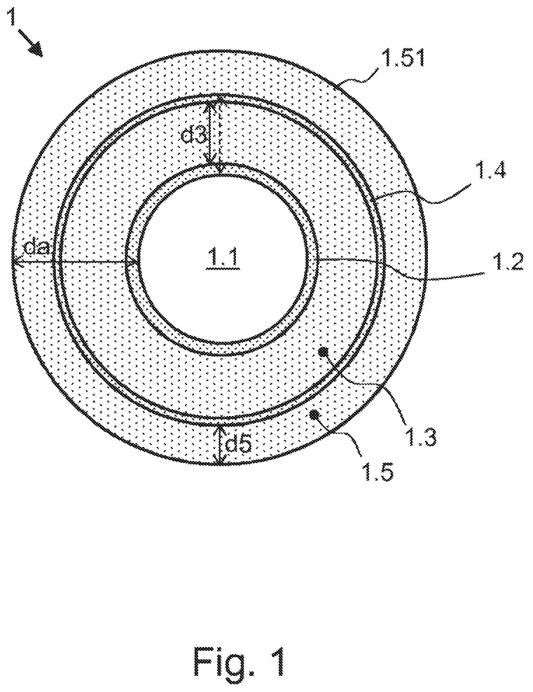

FIG. 1 a sectional view of a single prill produced according to embodiments;

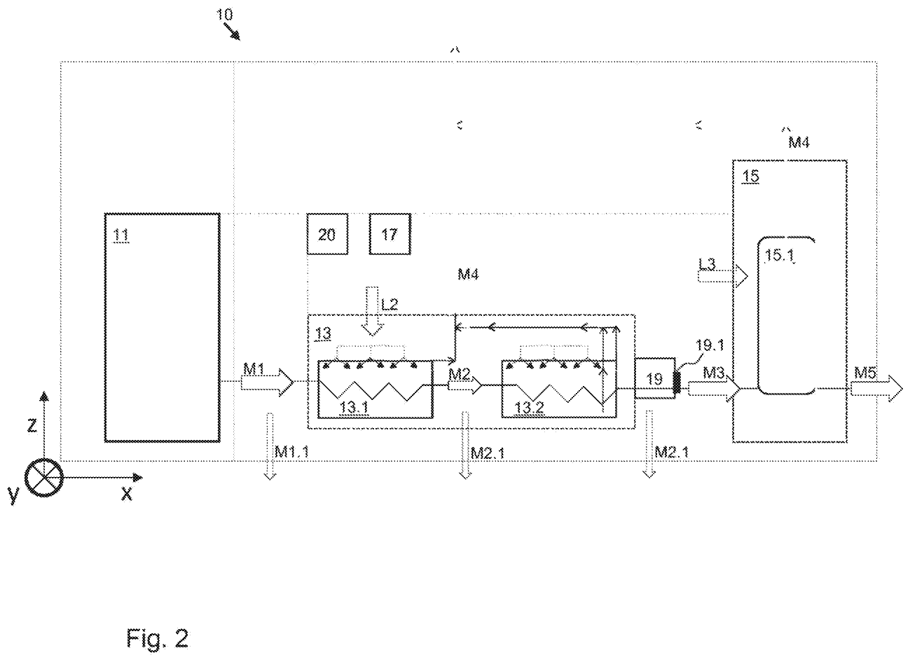

FIG. 2 a side view of a processing assembly according to an exemplary embodiment;

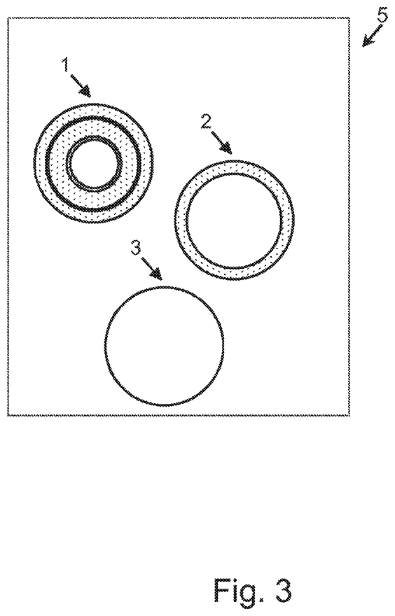

FIG. 3 a prill mixture with prills at least comprising prills produced according to embodiments;

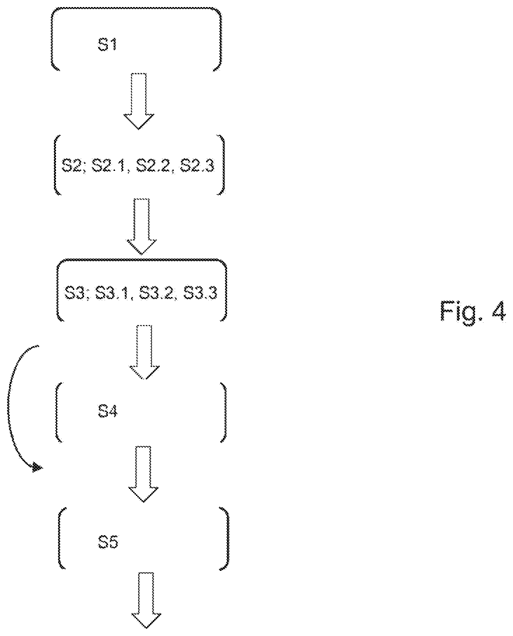

FIG. 4 a process diagram relating to individual process steps according to embodiments.

For reference numerals not described explicitly in respect of a single figure reference is made to the other figures.

FIG. 1 shows a single prill 1, having a core or carrier 1.1, having an optional layer of micronutrient additions 1.2 applied to the carrier 1.1 (for example micronutrient additions such as selenium Se, copper Cu, zinc Zn, applied by means of a drum coating device from a melt, from a solution in water (H2O) or from a solution in other solvents), having at least one first layer 1.3 (applied by means of a drum coating device from a solution in particular in acetone), in particular embodied as a PLA layer, having an optional layer of micronutrient additions 1.4 (for example micronutrient additions such as selenium Se, copper Cu, zinc Zn, applied by means of a drum coating device in particular from a solution in acetone), and having at least one second layer 1.5 (applied by means of a fluidized bed device from a solution in particular in acetone), in particular embodied as a PLA layer. Owing to the drum coating process, the first layer 1.3 can be imparted with a clew-like structure with a relatively high strength. Owing to the fluidized bed process, an outer skin or outer shell surface 1.51 of the second layer 1.5 can be imparted with a very dense surface structure. Instead of PLA, an alternative, biologically degradable polymer or a mixture of such polymers can also be applied for the respective first and/or second layer.

The following remarks can be made with respect to the individual layer thicknesses: The thickness d3 of the first layer 1.3 (possibly comprising one or more additional layers 1.2) is for example in the range from 10 μm to 300 μm, in particular is approx. 100 μm or 200 μm, and the thickness d5 of the second layer 1.5 (possibly comprising one or more additional layers 1.4) is for example in the range from 1 to 50 μm, with the absolute coating thickness being given here by summation and for example being in the range from 150 to 350 μm. The layers 1.3 and 1.5 can surround the additional layers 1.2, 1.4 here.

FIG. 2 shows a processing assembly 10 comprising a drum coating device 13 (drum coater) having a first drum coating unit 13.1 and a second drum coating unit 13.2, in particular designed as or comprising a drying unit, and further comprising a fluidized bed coating device 15 (fluidized bed coater) having at least one fluidized bed coating unit 15.1. Further, redundant fluidized bed coating units can optionally be provided. The assembly 10 can optionally also comprise a tower 11 for prill production (untreated prills or prills with conventional granulating aids, in particular UF solution).

The drum coating device 13 can be provided as a single apparatus or optionally can also consist of a grouping or assembly of a plurality of plant components. In particular, an optional drying can be effected separately.

By means of a negative pressure/positive pressure device 17, the desired operating pressure can be set in the respective coater 13, 15.

By means of a device 19 for receiving the prills that have been coated in the drum coater, the prills can be received or subjected to interim storage and can be transferred via the outlet 19.1 to the fluidized bed coater 15. Drying can optionally be effected in the device 19. The device 19 can be designed as a separate drying unit.

With a first material stream M1, in particular of untreated prills, prills are conveyed from the prilling tower 11 to the drum coating device 13 as first process stage. A supply of polymer and solvent L2 is effected in the drum coating device 13.

A material stream M1.1 (portion of M1) can optionally be directed to the storage facility. Downstream of the first drum coating unit 13.1, a material stream M2.1 (portion of M2) can optionally be directed to the storage facility. The percentage proportion of the portion can be adjusted depending on requirements, in particular by means of a control unit 20. The coupling of the control unit 20 to the respective devices and units is illustrated by the respective dash-dotted line.

With a further material stream M2 of prills coated with at least one first layer, the drum-coated prills are conveyed onwards from the corresponding drum coating unit, either to a further drum coating unit or to a drying unit, or as a further material stream M3 from the drum coating device 13 directly to the fluidized bed coating device 15 as second process stage. It is advantageous for the prills to remain warm along the material stream path M3, and so a temperature control device which surrounds the material stream path M3 at least in sections can be provided.

Optionally, an additional layer consisting of additives can be applied along each of the material stream paths M1, M2, M3, in particular in each case on a conveyor belt and/or during the transport. To this end, the respective material stream path M1, M2, M3, can be hermetically sealed off or surrounded at least in sections by a further coating device. This comparatively thin additional layer is configured to improve the physical properties of the prills (in particular abrasion resistance, compressive strength, resistance with respect to clumping), in particular in connection with the first material stream path M1. The coating with at least one additional layer on the carrier and/or on the first degradable layer can optionally also be effected in a separate (parallel, continuous or discontinuous) process.

A supply of polymer and solvent L3 is effected in the fluidized bed coating device 15, in particular with acetone or CO2 in the supercritical state, in particular in conjunction with atomizing fluid and/or air.

The respective supply of polymer and solvent L2, L3 can also include the supply of different polymer material and different solvents.

By means of a further media stream M4, the respective media can be discharged, with the media stream M4 comprising in particular the discharge, recycling (recovery) and/or disposal of solvents.

A solvent separation system (e.g. a cold trap, scrubbing) can be connected between drum coater 13 and fluidized bed coater 15. For the case where the intention is to use only a single type of solvent, the solvent is preferably collectively centrally fed to a separation system.

A separate dryer does not necessarily need to be provided. A drying function can also be fulfilled by the corresponding coater 13, 15.

In one embodiment, approx. 1% to 20% by weight of the first layer(s) is applied by the drum coating step(s) (first process stage according to the invention), and/or approx. 1% to 15% by weight of the second layer(s) is applied by the fluidized bed coating step(s) (second process stage according to the invention).

In a preferred embodiment, approx. 4% by weight of the first layer(s) is applied by the drum coating step(s), and/or approx. 1% by weight of the second layer(s) is applied by the fluidized bed coating step(s).

In a further (fourth) material stream M5, the two-stage coated end product can be provided, in particular in the form of a prill mixture consisting of two-layer coated prills (first type) and prills of at least one further type (second and/or third type, untreated or treated for the purposes of improving the physical properties). The proportions by weight of the mixture can be set individually, in particular by means of the control device 20, by regulation of the individual material streams.

Owing to the two-stage process, variations both to the process and to the layer structure and/or in relation to the material composition and/or in relation to the solvent selection can be made in a simple manner.

FIG. 4 shows a process diagram in which individual steps of the process according to the invention are elucidated. A first step S1 comprises supplying prills from a prilling tower. A second step S2 comprises one or more first coating steps, in particular a first drum coating step S2.1 and a second drum coating step S2.2 and optionally also a drying step S2.3 after the first and/or second coating step. In a third step S3 comprising one or more second coating steps, the at least one second layer 1.5 is applied, in particular in a first fluidized bed coating step S3.1 optionally followed by a second fluidized bed coating step S3.2 and optionally also followed by a drying step S3.3 after the first and/or second coating step. A fourth step S4 comprises the discharge or recycling of solvent, in particular CO2, and a fifth step S5 comprises the provision of prills or a prill mixture 5. Step S5 can also comprise the mixing, in particular according to predefined percentages, optionally specified by the control device.

### LIST OF REFERENCE NUMERALS

1 prill, in particular of the first type
1.1 core or carrier or carrier material
1.2 optional layer of micronutrient addition
1.3 first layer, in particular PLA layer
1.4 optional layer of micronutrient addition
1.5 second layer, in particular PLA layer
1.51 outer skin or outer shell surface
2 further prill, in particular of the second type
3 further prill, in particular of the third type
5 prill mixture
10 processing assembly
11 tower for prill production (untreated, unmodified prills)
13 drum coating device (drum coater)
13.1 first drum coating unit
13.2 second drum coating unit, in particular drying unit
15 fluidized bed coating device (fluidized bed coater)
15.1 fluidized bed coating unit
17 negative pressure/positive pressure device
19 device for receiving the prills that have been coated in the drum coater
19.1 outlet
20 control unit
d3 thickness of the first layer
d5 thickness of the second layer
da absolute coating thickness
M1 first material stream, in particular untreated prills
M1.1 material stream (portion) to the storage facility
L2 polymer and solvent supply
M2 further (second) material stream, in particular within the drum coating device
M2.1 material stream (portion) to the storage facility
L3 polymer and solvent supply
M3 further (third) material stream, in particular from the drum coating device to the fluidized bed coating device
M4 further media stream, in particular discharge of solvents
M5 further (fourth) material stream, in particular for providing a prill mixture
S1 first step, in particular supplying of prills from a prilling tower
S2 second step, in particular first coating step
52.1 first drum coating step
S2.2 second drum coating step
S2.3 drying step
S3 third step, in particular second coating step
53.1 first fluidized bed coating step
S3.2 second fluidized bed coating step
S3.3 drying step
S4 fourth step, in particular discharge or recycling of solvent
S5 fifth step, in particular provision of prills or a prill mixture

1.-14. (canceled)

15. A process for producing prills or granules, the process comprising:
coating a carrier material of respective prills with a first degradable polymer layer in a drum coating step; and
coating the prills with a second degradable polymer layer on top of the first degradable polymer layer in a fluidized bed coating step.

16. The process of claim 15 wherein coating the prills with the second degradable polymer layer comprises introducing the prills into a fluidized bed coater after the drum coating step, and/or wherein the fluidized bed coating step is performed spatially adjacent alongside the drum coating step.

17. The process of claim 15 wherein a rest phase or a drying phase of between 1 to 3 minutes occurs after coating the carrier material of the respective prills and before coating the prills with the second degradable polymer layer.

18. The process of claim 15 wherein at least one of:
a proportion by weight of the degradable polymer layers is in a range from 0.05% to 20% of a mass of each prill;
a proportion by weight of the first degradable polymer layer is in a range from 0.05% to 15% of a mass of each prill;
a proportion by weight of the second degradable polymer layer is in a range from 0.05% to 5% of a mass of each prill;
a layer thickness of the degradable polymer layers in absolute terms is in a range from 1 to 500 μm;
the first degradable polymer layer is at least as thick as the second degradable polymer layer; or
a ratio of layer thicknesses or proportions by weight of the first degradable polymer layer compared to the second degradable polymer layer is in a range from 20:1 to 1:1.

19. The process of claim 15 wherein at least one of:
in the drum coating step, setting a temperature in a range from 0 to 130° C.; or
in the fluidized bed coating step, setting a temperature in a range from 0 to 90° C.

20. The process of claim 15 wherein at least one of:
in the drum coating step, setting a pressure in a range from 1 to 0 bara; or
in the fluidized bed coating step, setting a pressure in a range from 1 to 10 000 mbar.

21. The process of claim 15 wherein at least one of:
the first and second degradable polymer layers each comprises a layer of biologically degradable PLA; or
the first degradable polymer layer has a clew-like, pore-rich structure and the second degradable polymer layer has a plaster-like, dense, low-pore structure

22. The process of claim 15 wherein in at least one of the coating steps a chlorine-free solvent is used, and/or wherein in the fluidized bed coating step chlorine-free solvent comprising CO2 is used.

23. A processing assembly for production of prills or granules, the processing assembly comprising:
a drum coater as a first process stage;
a fluidized bed coater as a second process stage that is downstream of the first process stage, wherein each of the drum coater and the fluidized bed is configured for coating the prills with a biologically degradable polymer layer; and
a device for generating a negative pressure or a positive pressure and for generating a pressure difference between the first and second process stages.

24. The processing assembly of claim 23 comprising:
a device for receiving the prills that have been coated in the drum coater, the device for receiving being configured for transferring the prills to the fluidized bed coater and having an outlet or a coupling corresponding to an inlet of the fluidized bed coater; and
a device having a drying function interposed between the drum coater and the fluidized bed coater.

25. Prills having at least two layers produced by at least two-stage coating of a carrier material of the prills, with a first degradable polymer layer applied by drum coating and with a second degradable polymer layer applied by fluidized bed coating, the prills produced by a process comprising:
coating a carrier material of respective prills with the first degradable polymer layer in a drum coating step; and
coating the prills with the second degradable polymer layer on top of the first degradable polymer layer in a fluidized bed coating step.

26. A mixture of prills comprising at least one of:
the prills of claim 25 mixed with a second type of prills with an at least one mechanically-stabilizing layer; or
the prills of claim 25 mixed with a second type of prills without any coating.
